(19) United States
(12) Patent Application Publication
(10) Pub. No.: US 2026/0024130 A1
(43) Pub. Date: Jan. 22, 2026

(54) METHODS, SYSTEMS, ARTICLES OF MANUFACTURE AND APPARATUS TO FACILITATE PARTICIPANT CONNECTION

(71) Applicant: Nielsen Consumer LLC, Chicago, IL (US)

(72) Inventors: Edouard NATTEE, Paris (FR); Marie LAPLACE, Montrouge (FR); Louis BALLADUR, Paris (FR); Nicolas REMIA, Paris (FR)

(21) Appl. No.: 18/993,394

(22) PCT Filed: Jul. 12, 2022
(86) PCT No.: PCT/IB2022/000410

§ 371 Date: Jan. 10, 2025

(51) Int. Cl. G06Q 30/0601

(52) U.S. Cl. CPC G06Q 30/0641

(57) ABSTRACT

Methods, apparatus, systems, and articles of manufacture are disclosed to facilitate participant connection. An example apparatus includes at least one memory, machine readable instructions, and processor circuitry to at least one of instantiate or execute the machine readable instructions to authorize access to an e-mail account, parse messages corresponding to the e-mail account to identify parameters, generate a list of candidate products associated with the parameters, publish the list with a first combination of information, in response to a first trigger, publish a second combination of information, and cause one of the candidate products from the list of candidate products to be at least one of removed or maintained based on a second trigger.

### FIELD OF THE DISCLOSURE

This disclosure relates generally to market participant management and, more particularly, to methods, systems, articles of manufacture and apparatus to facilitate participant connection.

### BACKGROUND

In recent years, mobile devices have enabled consumer shopping opportunities. Mobile devices enable consumer access to location data, retailer data and product information data corresponding to any number of retailers and/or products sold by such retailers.

### BRIEF DESCRIPTION OF THE DRAWINGS

FIG. 1 is a schematic illustration of an example system, including transaction circuitry, to facilitate participant connection.

FIG. 2A is a block diagram of the transaction circuitry of FIG. 1 to facilitate participant connection.

FIG. 2B is a screenshot of an example app exchange to enable downloading and installation of an example transaction app.

FIG. 2C is a screenshot of another example app exchange that is initially accessed via a web page that includes a QR code to be scanned by a candidate participant.

FIG. 2D is a screenshot of an example e-mail configuration.

FIG. 2E is a screenshot to enable notifications and/or notices associated with account status when participants send contact requests.

FIG. 2F is a screenshot to enable compliance with one or more jurisdictional requirements.

FIG. 2G is a screenshot of different product brands are listed for candidate inclusion during a search effort.

FIG. 2H is a screenshot of candidate categorical information to be searched.

FIG. 2I is a screenshot of an example list of products detected in historical e-mail messages corresponding to the participant.

FIG. 2J is a screenshot of an example public/private designation UI rendered by the example transaction circuitry of FIGS. 1 and 2A.

FIG. 2K is a screenshot of an example public/private designation UI rendered by the example transaction circuitry of FIGS. 1 and 2A to facilitate changing selected items to a private status, thereby preventing public viewing.

FIG. 2L is a screenshot of an example product information UI that includes editable fields corresponding to products to be sold.

FIG. 2M is a screenshot of an example offer notification.

FIG. 2N is a screenshot of an example refusal dialog.

FIG. 2O is a screenshot of an example acceptance dialog.

FIG. 2P is a screenshot of an example user interface to reveal available categories of products in a selected geography of interest.

FIG. 2Q is a screenshot of a purchase dialog user interface.

FIGS. 3-8 are flowcharts representative of example machine readable instructions and/or example operations that may be executed by example processor circuitry to implement the transaction circuitry of FIGS. 1 and 2A.

FIG. 9 is a block diagram of an example processing platform including processor circuitry structured to execute the example machine readable instructions and/or the example operations of FIGS. 3-8 to implement the transaction circuitry of FIGS. 1 and 2A.

FIG. 10 is a block diagram of an example implementation of the processor circuitry of FIG. 9.

FIG. 11 is a block diagram of another example implementation of the processor circuitry of FIG. 9.

FIG. 12 is a block diagram of an example software distribution platform (e.g., one or more servers) to distribute software (e.g., software corresponding to the example machine readable instructions of FIGS. 3-8) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Consumer purchases may result in an initial period of time in which a purchased product is used followed by a subsequent period of time in which the purchase product is either not used or used much less frequently. Reasons that a purchased product is not used or used less frequently include, but are not limited to consumer disinterest, consumer product use fatigue, or circumstances where the consumer forgets that they own the previously purchased product. For example, a previously purchased pair of pants may initially be used in response to a particular fashion trend. After some period of time, the purchased pair of pants is stored in, for instance, the consumer's closet and forgotten about and/or otherwise no longer used.

In some examples, previously purchased products retain a particular market value and, if offered for sale would result in an opportunity for the consumer to recapture a portion of the original purchase price. However, in the event the consumer does not think of the previously purchased product, that product becomes a lost financial opportunity for the consumer. Examples disclosed herein enable consumer transaction opportunities for products that consumers have previously purchased, but may have forgotten about.

In some examples, consumers may be aware of previously purchased products for which they no longer have a need to retain, but such consumers lack sufficient transportation opportunities to travel (e.g., drive by car, travel by train, travel by bus, etc.) to a location (e.g., a consignment store, a flea-market, a farmer's market, etc.) to sell the previously purchased product. As such, examples disclosed herein facilitate identification of candidate consumers in a threshold proximity to the seller's location, thereby allowing future transactions to occur on a local scale that is accessible by other modes of transportation (e.g., walking, biking).

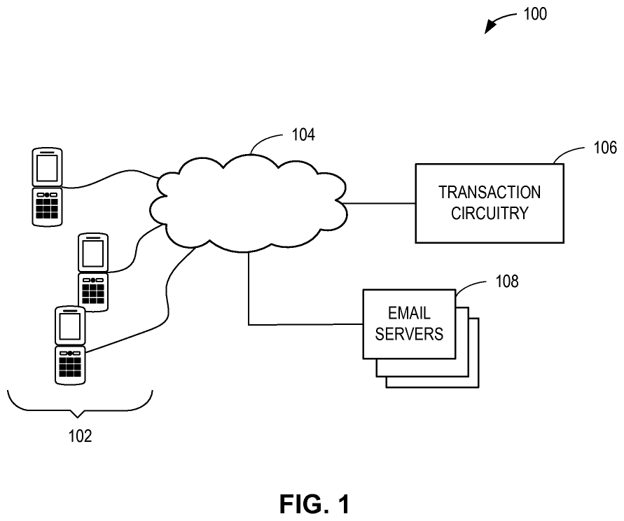

FIG. 1 is a schematic illustration of an example system to facilitate participant connection 100. In the illustrated example of FIG. 1, the system 100 includes computing devices 102 communicatively connected to an example network 104 (e.g., the Internet). Example computing devices 102 include, but are not limited to mobile phones, personal computers, laptops, tablets, etc. The illustrated example system 100 of FIG. 1 includes a transaction circuitry 106 communicatively connected to the example network 104. As described in further detail below, the example transaction circuitry 106 communicates with any number of electronic mail (e-mail) servers 108 corresponding to e-mail accounts associated with the example computing devices 102. In some examples, the transaction circuitry 106 is a server to process requests from any number of computing devices that execute an app. In some examples, the transaction circuitry 106 is located within each example computing device 102 to interact with other ones of the computing devices that also include the example transaction circuitry 106 (e.g., as hardware, as software, as a combination of hardware and software).

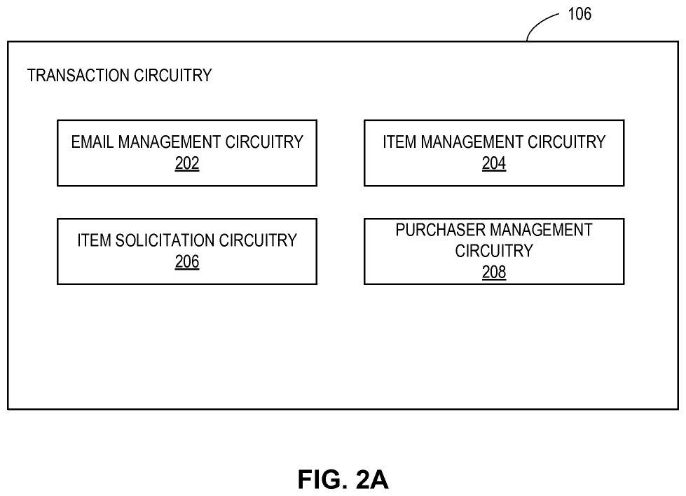

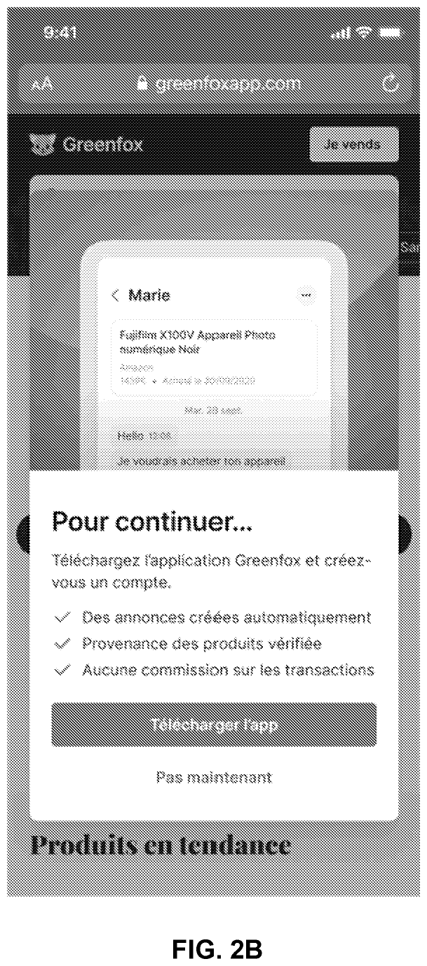

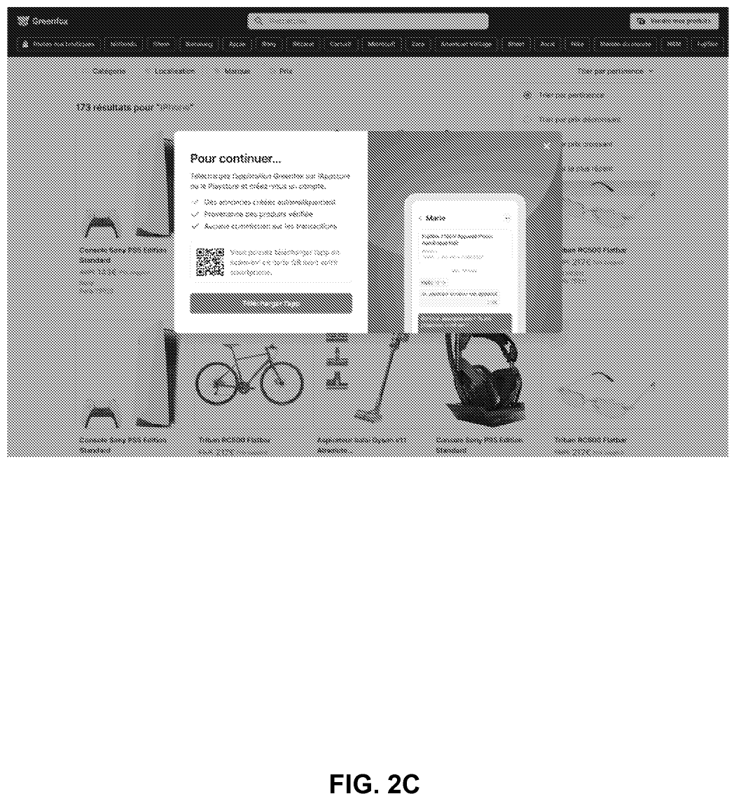

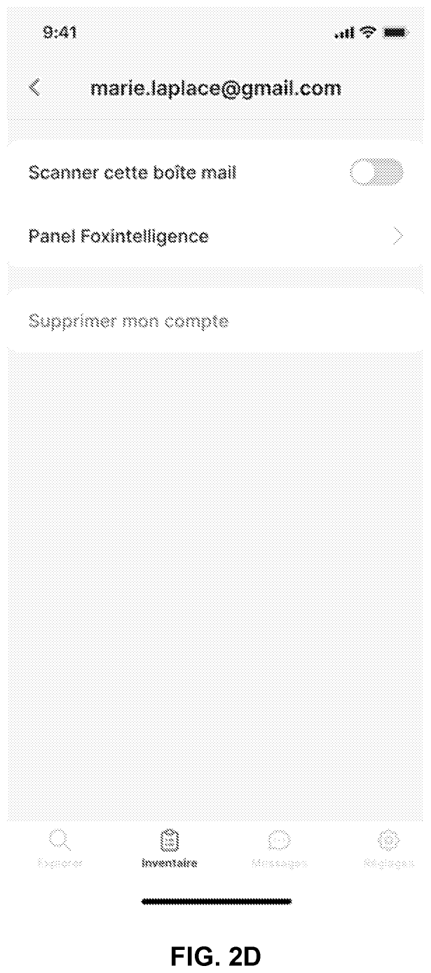

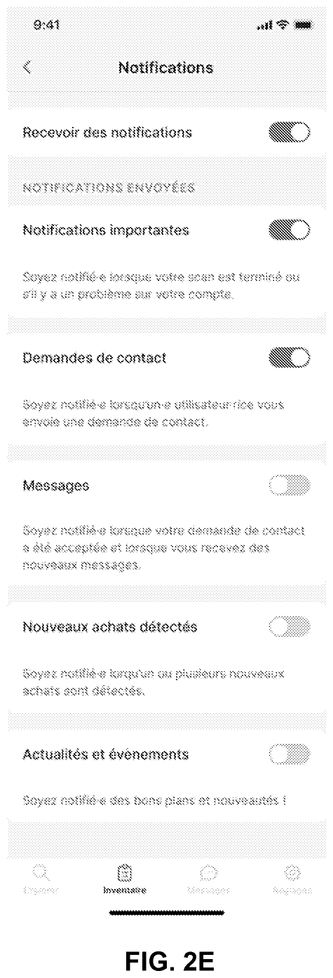

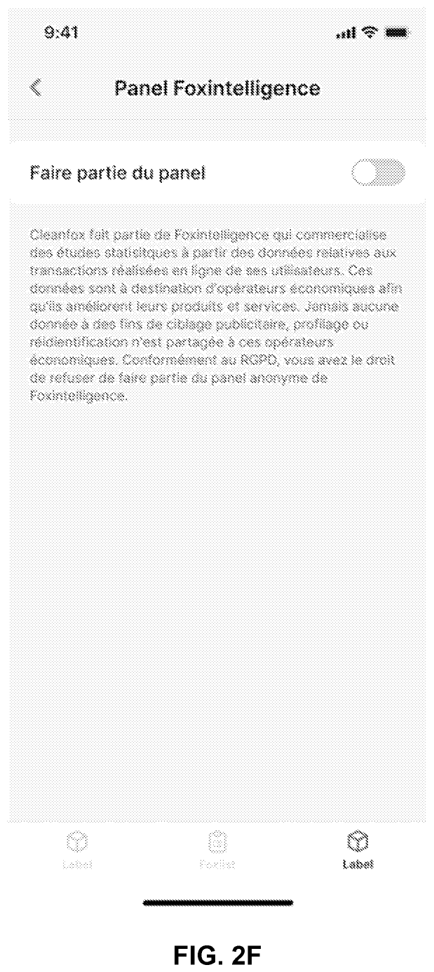

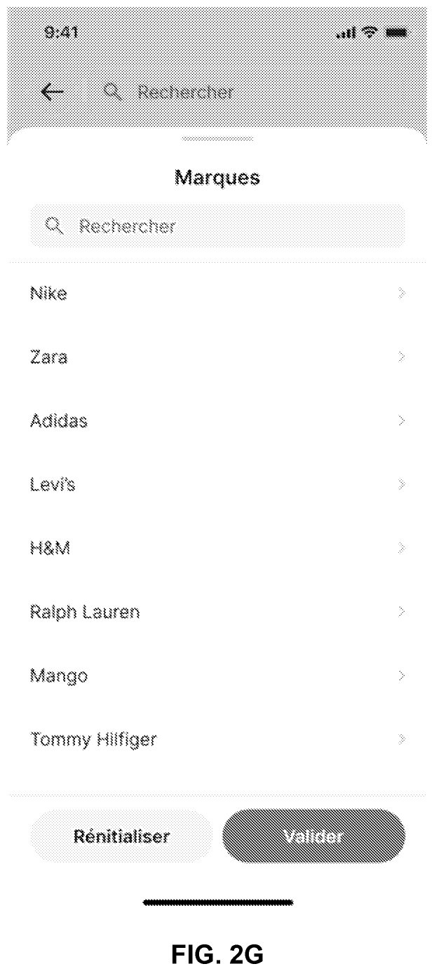

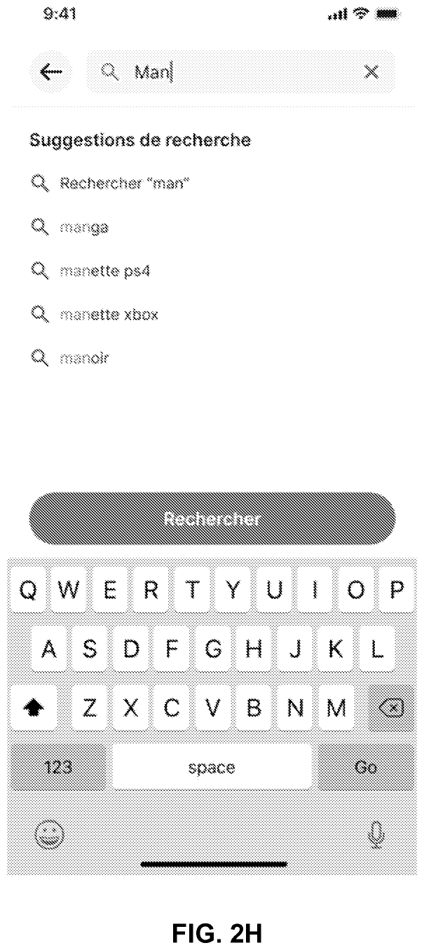

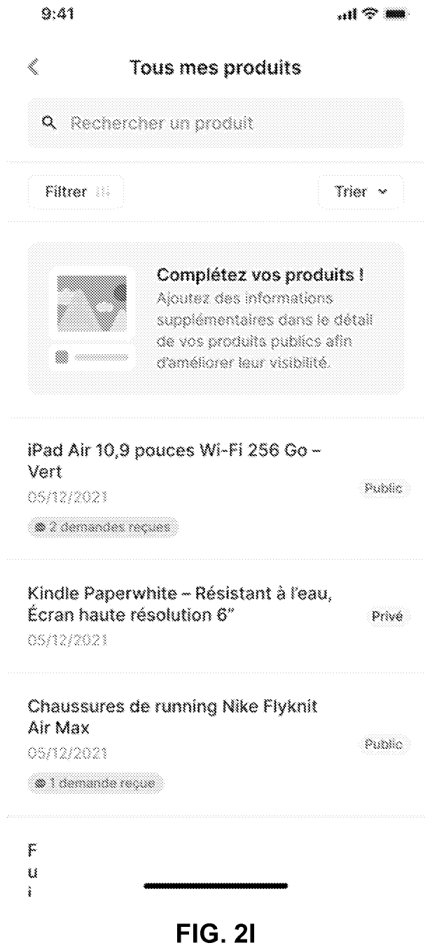

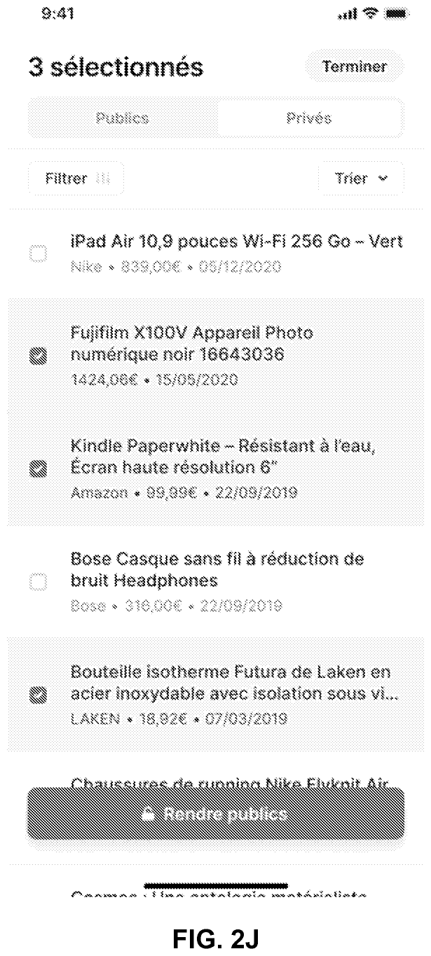

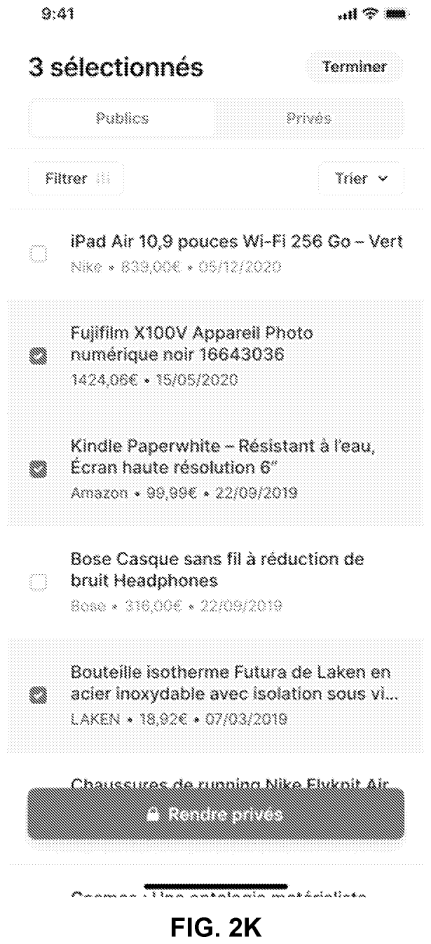

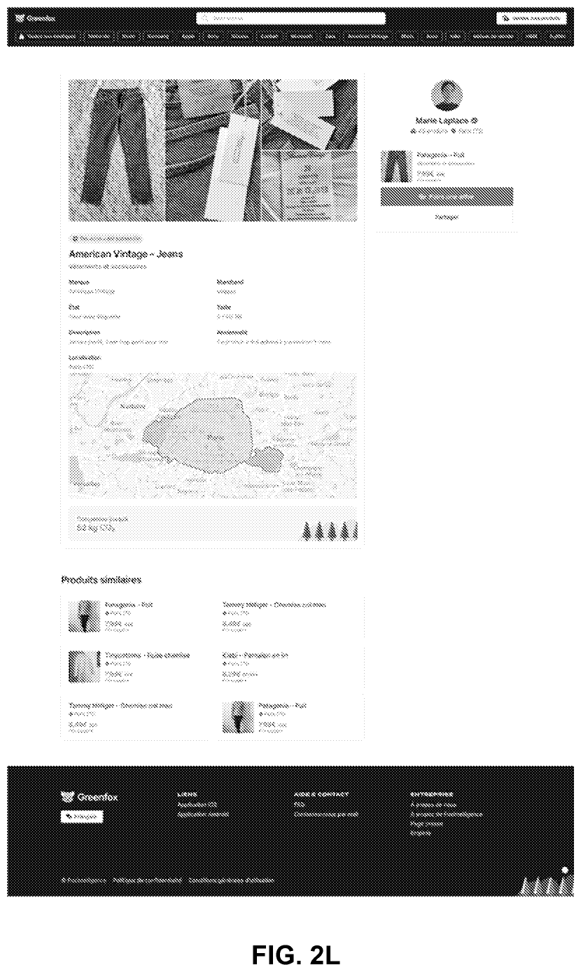

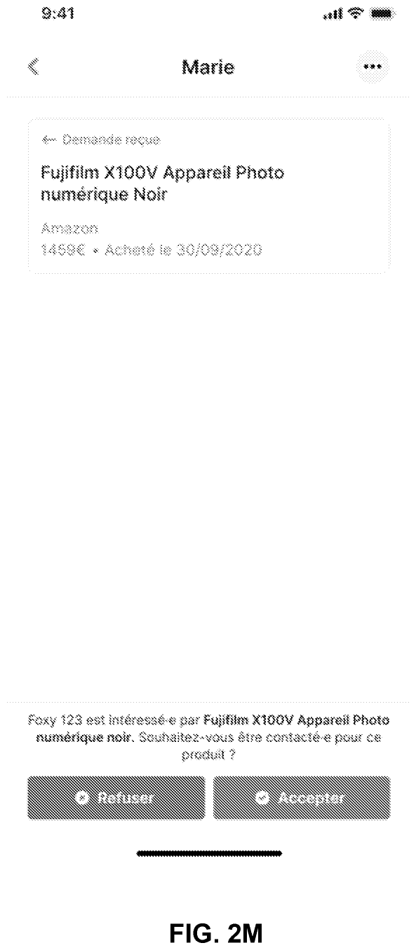

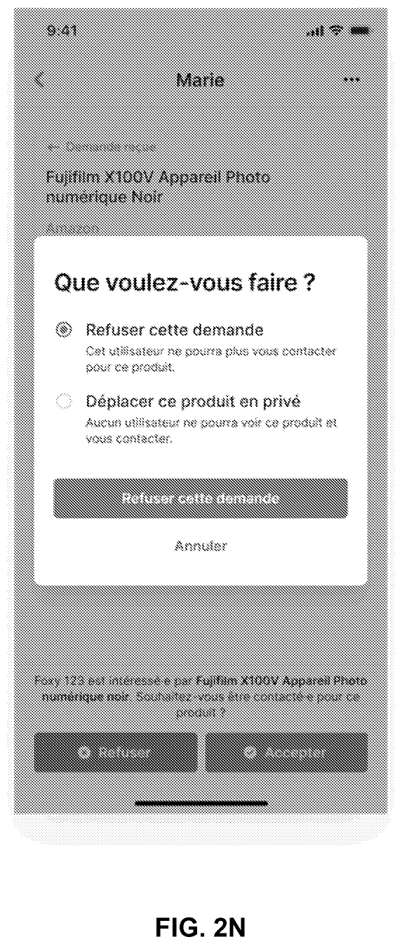

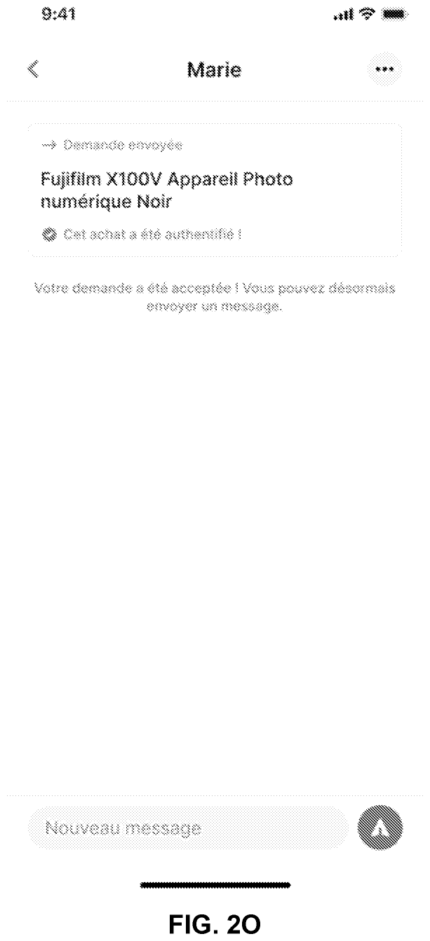

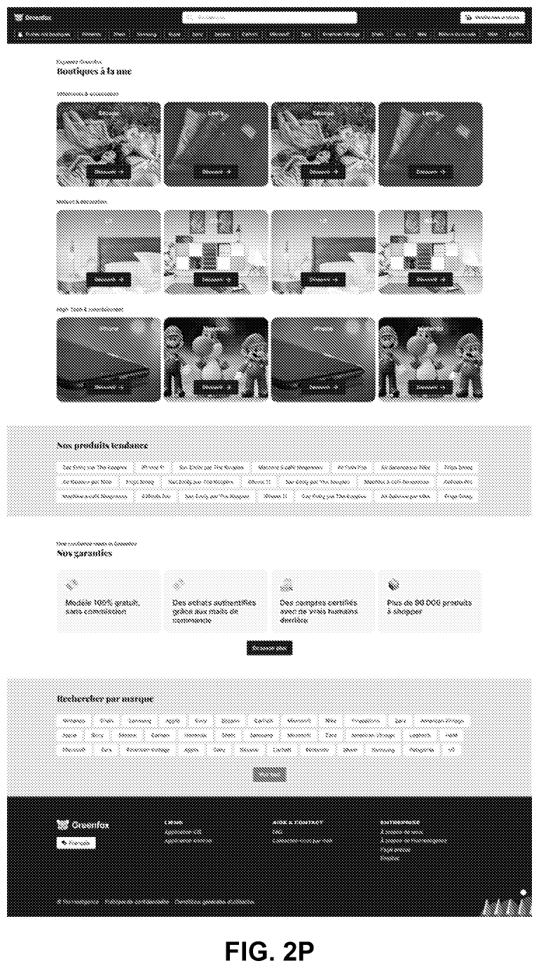

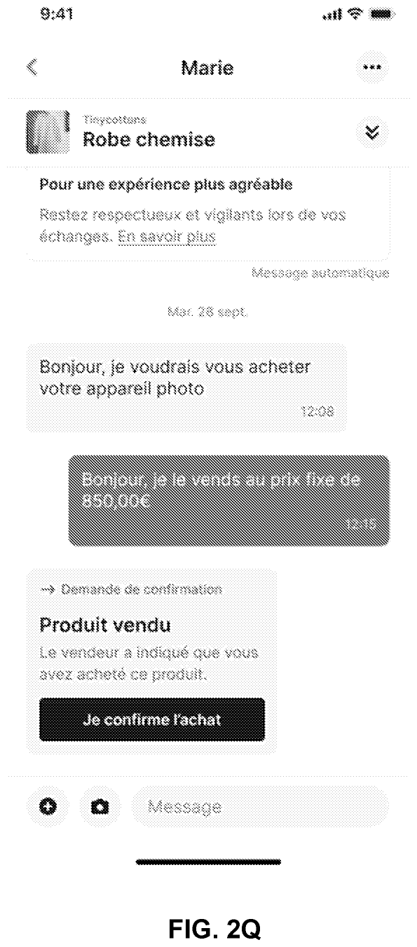

FIG. 2A illustrates additional detail corresponding to the example transaction circuitry 106 of FIG. 1. In the illustrated example of FIG. 2A, the transaction circuitry 106 includes example e-mail management circuitry 202, example item management circuitry 204, example item solicitation circuitry 206, example purchaser management circuitry 208, and example buyer management circuitry 210. In operation, the example transaction circuitry 106 determines whether to process a request to sell items or process a request to purchase items. In particular, a user may install an example transaction app (e.g., mobile telephone app) on their mobile device and/or access a transaction website to facilitate candidate participant connections. Transaction apps may be accessible to participants through mobile device app exchanges, such as the Apple® AppStore, the Android®) App Store (e.g., Google Play®), etc. FIG. 2B illustrates a screenshot of an example app exchange to enable downloading and installation of the example transaction app. FIG. 2C illustrates a screenshot of another example app exchange that is initially accessed via a web page that includes a QR code to be scanned by a candidate participant.

When the transaction app is installed, or when a participant creates account credentials (e.g., via the transaction app, via the web, etc.), the example transaction circuitry 106 renders any number of user interface (UI) displays to configure the account, configure account behaviors and/or interact with the participant. FIG. 2D illustrates a screenshot of an example e-mail configuration. In the illustrated example of FIG. 2D, the transaction circuitry 106 retrieves entry of an e-mail address and a toggle control to either authorize or de-authorize access by the transaction app of mailbox scanning capabilities. As such, examples disclosed herein enable participants to retain complete control over access by the transaction app of information that could be considered personal. In some examples, the e-mail management circuitry 202 authorizes access to an e-mail account by authenticating the example transaction circuitry 106 with credentials (e.g., a username, a password, biometric information, tokens, etc.). In some examples, the transaction circuitry 106 does not need to provide credentials to a corresponding e-mail server associated with a user of the electronic device 102. Instead, the example e-mail management circuitry 202 is provided access to an e-mail app of the electronic device 102 that permits screen viewing and/or screen data acquisition. As such, users of the example transaction circuitry 106 may take more comfort in the fact that e-mail credentials are not at risk of being properly stored and/or otherwise managed by the app facilitated by the transaction circuitry 106.

Examples disclosed herein provide different types of participant control over behavior of the transaction app (the transaction circuitry 106 of FIGS. 1 and 2). FIG. 2E illustrates a screenshot (e.g., generated by the example transaction circuitry 106) to enable notifications, notices associated with account status, notifications when other participants send contact requests, etc. FIG. 2F illustrates a screenshot to enable compliance with one or more jurisdictional requirements, such as the General Data Protection Regulation. Generally speaking, examples disclosed herein enable any type of account control, notification control and/or participant privacy control, and examples discussed above are not limiting.

When the example transaction circuitry 106 detects that a participant desires to sell products, the example e-mail management circuitry 202 determines whether the participant has provided authorization to scan, review, examine and/or otherwise parse one or more e-mail accounts on the device (e.g., an e-mail account on the mobile device). If not, the example e-mail management circuitry 202 prohibits any access to e-mail messages and/or accounts. However, in the event authorization is detected by the example e-mail management circuitry 202, such as when a participant provides authorization via the example user interface of FIG. 2D, the e-mail management circuitry 202 applies access credentials to one or more e-mail servers corresponding to one or more participant e-mail accounts. Alternatively, and as described above, in some examples e-mail credentials are not needed and instead the e-mail management circuitry 202 is provided access to one or more e-mail apps associated with the computing device 102 for the purpose of scraping and/or otherwise taking screen shots to be parsed.

In some examples, the e-mail management circuitry 202 retrieves one or more parameters and/or categories of interest to identify and/or otherwise narrow a list of product type results. Parameters may include keywords, threshold age values for e-mail messages and/or categories of interest. In some examples, parameters indicative of a threshold age of an e-mail message allow an abbreviated list of matching e-mail messages that might be more easily managed than a full list of candidate e-mail messages from a full history of an e-mail account. Categories of interest may include, but are not limited to men's clothing, women's clothing, electronics (e.g., computers, laptops, mobile phones, cameras), jewelry, etc. The example e-mail management circuitry 202 retrieves and/or otherwise applies category keywords corresponding to the one or more categories of interest and performs an e-mail search based on those keywords. In other words, keywords may be used to identify relevant historical e-mail messages that contain an indication of prior product purchases. Prior product purchases may be identified based on receipts sent to the participant e-mail account, in which the receipt contains product description information, product quantity information, product purchase price, date of purchase, etc. Stated differently, without some keyword parameters to be used in the e-mail search for previously purchased products, some results could contain product information that is not well suited and/or otherwise appropriate for resale, such as receipts corresponding to grocery stores (e.g., receipts having product information corresponding to fruits, vegetables, toiletries), receipts corresponding to spa services (e.g., massage therapy services), medical services (e.g., doctor visits, dentist visits, etc.), receipts corresponding to restaurants, etc.

To assist the participant with one or more selections of categories and/or keywords of interest that may identify relevant products previously purchased, the example e-mail management circuitry 202 may publish and/or otherwise render a list of candidate products associated with the aforementioned parameters. In some examples, the list of candidate products is a first combination of information rendered and/or otherwise published by the e-mail management circuitry 202, which can include product names, product descriptions, product sale prices, product original sale prices (e.g., when purchased new), product age, etc. The example e-mail management circuitry may also render a screenshot as shown in FIG. 2G. In the illustrated example of FIG. 2G, different product brands are listed for candidate inclusion during a search effort. In some examples, the e-mail management circuitry 202 renders and processes one or more UIs to receive typed-in keywords to reveal candidate categorical information to be searched, as shown in FIG. 2H.

The example item management circuitry 204 generates a private product list based on results of the e-mail scan performed by the example e-mail management circuitry 202. FIG. 2I is a screenshot of an example list of products detected in historical e-mail messages corresponding to the participant. In the illustrated example of FIG. 2I, products are initially assigned with a private status. Again, examples disclosed herein enable full control by the participants regarding what information is allowed to be public and/or whether public information is to be assigned (or reassigned) with a private status. In the illustrated example of FIG. 2I, a first product (e.g., an iPad Air) is assigned a public status (e.g., on a prior occasion and in response to authorization by the participant), and a second product (e.g., a Kindle) is assigned a private status by default.

FIG. 2J is a screenshot of an example public/private designation UI rendered by the example item management circuitry 204. In the illustrated example of FIG. 2J, the item management circuitry 204 facilitates checkboxes next to each participant item that is currently designated with a private status and causes the checked items to be assigned a public status, thereby allowing candidate buyers to review (as described in further detail below). On the other hand, for items currently having a public status, FIG. 2K illustrates a screenshot of an example public/private designation UI rendered by the example item management circuitry 204 to facilitate changing selected items to a private status, thereby preventing public viewing.

The example item solicitation circuitry 206 generates one or more UIs to facilitate product detail editing for products that have been detected in prior e-mail messages. FIG. 2L is a screenshot of an example product information UI that includes editable fields corresponding to a product title (e.g., “American Vintage—Jeans”), a product category (e.g., “Clothes and Accessories”), a merchant name (e.g., Veepee), a product state or condition (e.g., “New with tag”), a product size, and a location. Example product information shown in FIG. 2L is not limiting and is discussed above for convenience. Any number of additional and/or alternate product information fields may be generated by the example item solicitation circuitry 206 without limitation.

In some examples, the item solicitation circuitry 206 calculates a candidate sale price for the selling participant. For instance, the item solicitation circuitry 206 may calculate a candidate sale price based on a threshold boundary between the original purchase price and an average purchase price for similar items currently being sold. As shown near the bottom of FIG. 2L, the item solicitation circuitry 206 renders similar products, corresponding prices and general locations in which the product is (or has been) sold. In some examples, the item solicitation circuitry 206 calculates a carbon offset value. In the illustrated example of FIG. 2L, the item solicitation circuitry 206 calculated a carbon offset value of 52 kg of CO₂, which is based on any number of parameters. For example, the carbon offset value may be calculated based on an anticipated amount of CO₂ required to purchase this product new from a retail store that is located outside the example local geography. Stated differently, an assumption may be made that a vehicle used to drive to the nearest retailer would generate a particular amount of CO₂, which can be offset in the event the product is instead purchased locally without the need for car, bus and/or train travel services.

The example product location in FIG. 2L is shown as a first resolution in the interest of participant privacy. In particular, detailed address information associated with the selling participant is not provided to respect privacy concerns. However, examples disclosed herein enable participant contact at a later time in which the buying/selling parties are free to exchange (e.g., the example item solicitation circuitry 206 publishes and/or otherwise renders) a second combination of information. Such information (e.g., a second resolution of granular address information to allow the parties to meet). The example item solicitation circuitry 206 publishes one or more products so that candidate buyers within the first resolution can view the one or more products and information corresponding thereto. The example of FIG. 2L is sometimes referred to herein as a product sheet, and the example item solicitation circuitry 206 may create an item sheet for every candidate product that is being sold by the seller participant. As described above, item sheets may be generated by the item solicitation circuitry 206 to include the first combination of information, such as a name of the product, a name of a merchant from which the product was originally purchased, a date of first purchase (e.g., to reveal an age of the product for sale), an original purchase price, a resale price (e.g., based on market estimations), and carbon footprint estimates using factors from industry data sources (e.g., the French Agency for Ecological Transition).

When the example item solicitation circuitry 206 detects an offer has been received, response options are rendered to the selling participant as a second combination of information. FIG. 2M is a screenshot of an example offer notification rendered by the example item solicitation circuitry 206. In the illustrated example of FIG. 2M, the item solicitation circuitry 206 renders a notification that a candidate buyer (“Foxy 123”) would like to communicate with the selling participant. The example item solicitation circuitry 206 detects an input corresponding to one of an acceptance to the communication offer or a rejection of the communication offer. In the event the item solicitation circuitry 206 detects a refusal, then an option to either refuse the request or remove the public status of the product is rendered, as shown in FIG. 2N. However, in the event the item solicitation circuitry 206 detects acceptance, then the candidate buyer receives a corresponding message and/or notification to that effect, as shown in FIG. 2O, as described in further detail below. For instance, acceptance may result in the publication and/or otherwise rendering of the second combination of information, which may include, but is not limited to an offer price, a counteroffer price and/or address information. While the first combination is published and/or otherwise rendered to a public audience, the second combination is published and/or otherwise rendered to a private audience, such as a single candidate purchase participant that has shown an interest in one of the selling participant items/products. In some examples, an offer to purchase is a first trigger for the example transaction circuitry 106. In some examples, an acceptance to the offer to purchase is a second trigger for the example transaction circuitry 106. Because the second trigger may include either an acceptance or a rejection to the purchase offer (e.g., the first trigger), the effect of the second trigger may include one of removing one of the listed products from public viewing, or maintaining the one of the listed products for public viewing.

While examples disclosed above generally relate to the transaction app (e.g., the example transaction circuitry 106 facilitating a client/participant selling experience on an example mobile device 102), examples disclosed herein also facilitate client buying experiences from respective mobile devices 102. For example, a candidate purchasing participant downloads an app and/or creates an account in a manner similar to the process described above. Additionally, the example purchaser management circuitry 208 detects a selection by the candidate purchasing participant of a geography of interest that they would like to consider. The example purchaser management circuitry 208 renders search terms and/or categories of candidate products that reside within the selected geography of interest.

FIG. 2P is a screenshot of an example UI rendered by the purchaser management circuitry 208 to reveal available categories of products in the selected geography of interest. For instance, in the illustrated example of FIG. 2P, available products in the selected geography of interest include clothing by two separate manufacturers (e.g., Sezane and Levi's), home products by Ikea, and electronics from Apple and Nintendo. The purchaser management circuitry 208 presents a list of candidate products to the participant purchaser for which offers can be made by the purchaser participant. In some examples, the purchaser management circuitry 208 ranks the list based on price, based on search term similarity (e.g., “pants”), and/or based on a carbon footprint value. For instance, particular items that exhibit a relatively largest carbon footprint savings may be rendered by the purchaser management circuitry 208 at the beginning of a list of candidate products the purchaser participant may select.

In the event the candidate purchaser participant wishes to make an offer for one of the products being sold by the seller participant, the example purchaser management circuitry 208 and/or the example item solicitation circuitry 206 renders a UI similar to that described above in connection with FIG. 2M. If accepted, the example purchaser management circuitry 208 facilitates a release of contact information so that the purchaser participant and the seller participant can choose when and how to meet to conduct the transaction. In some examples, the purchaser management circuitry 208 renders a message dialog UI, as shown in FIG. 2Q. In the illustrated example of FIG. 2Q, the candidate purchaser participant initiated a request to purchase an item. In some examples, the purchaser participant does not have any identity information associated with the seller participant, and the seller participant does not have any identity information associated with the purchaser participant. Stated differently, the candidate participants are only matched when both parties agree to completing the transaction, thereby maintaining privacy for all participants.

As described above, FIG. 2A is a block diagram of example transaction circuitry 106 to perform participant connections. The transaction circuitry 106 of FIGS. 1 and 2A may be instantiated (e.g., creating an instance of, bring into being for any length of time, materialize, implement, etc.) by processor circuitry such as a central processing unit executing instructions. Additionally or alternatively, the transaction circuitry 106 of FIGS. 1 and 2A (whether implemented as a server and/or as clients within computing devices 102) may be instantiated (e.g., creating an instance of, bring into being for any length of time, materialize, implement, etc.) by an ASIC or an FPGA structured to perform operations corresponding to the instructions. It should be understood that some or all of the circuitry of FIGS. 1 and 2A may, thus, be instantiated at the same or different times. Some or all of the circuitry may be instantiated, for example, in one or more threads executing concurrently on hardware and/or in series on hardware. Moreover, in some examples, some or all of the circuitry of FIGS. 1 and 2A may be implemented by microprocessor circuitry executing instructions to implement one or more virtual machines and/or containers.

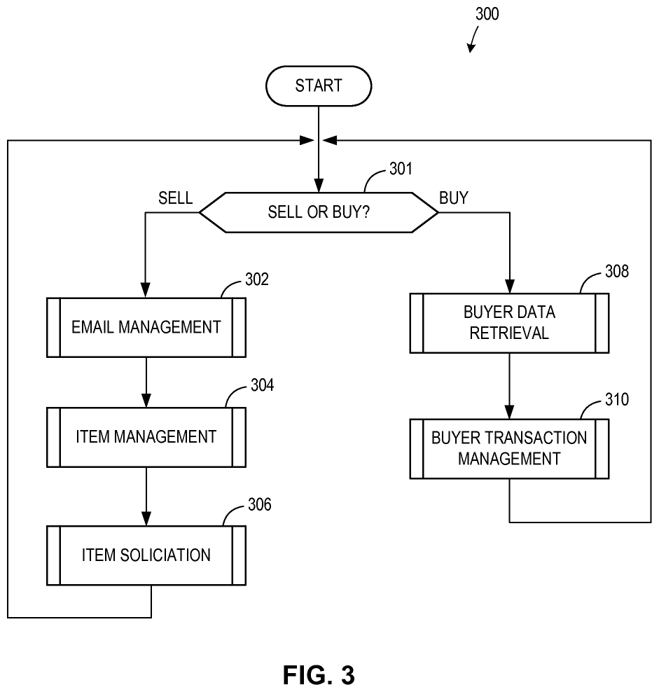

In some examples, the e-mail management 202, the item management 204, the item solicitation 206, the purchaser management 208 and/or the transaction 106 is/are instantiated by processor circuitry executing instructions and/or configured to perform operations such as those represented by the flowcharts of FIGS. 3-8.

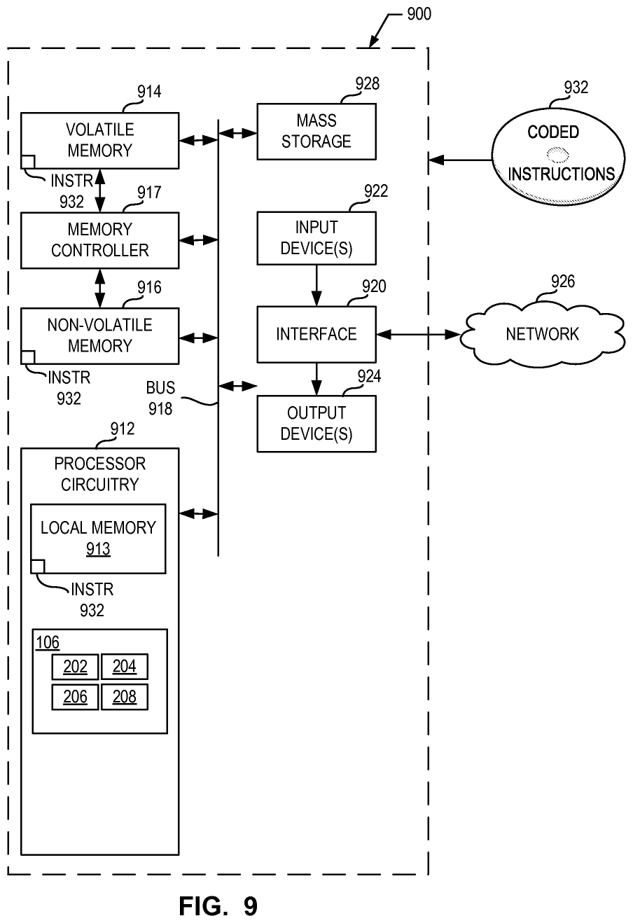

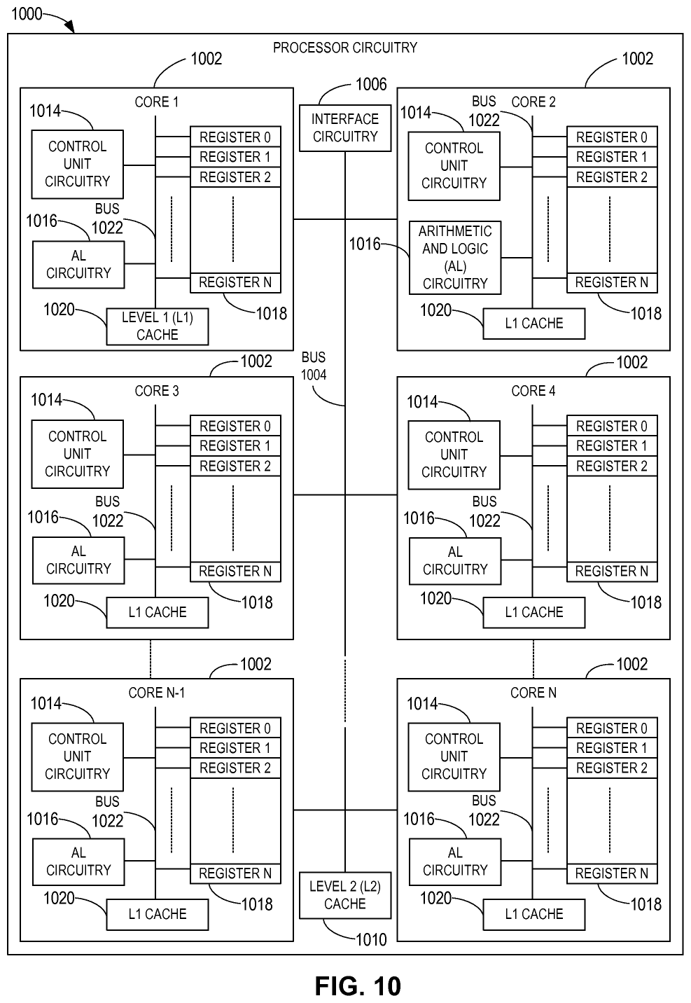

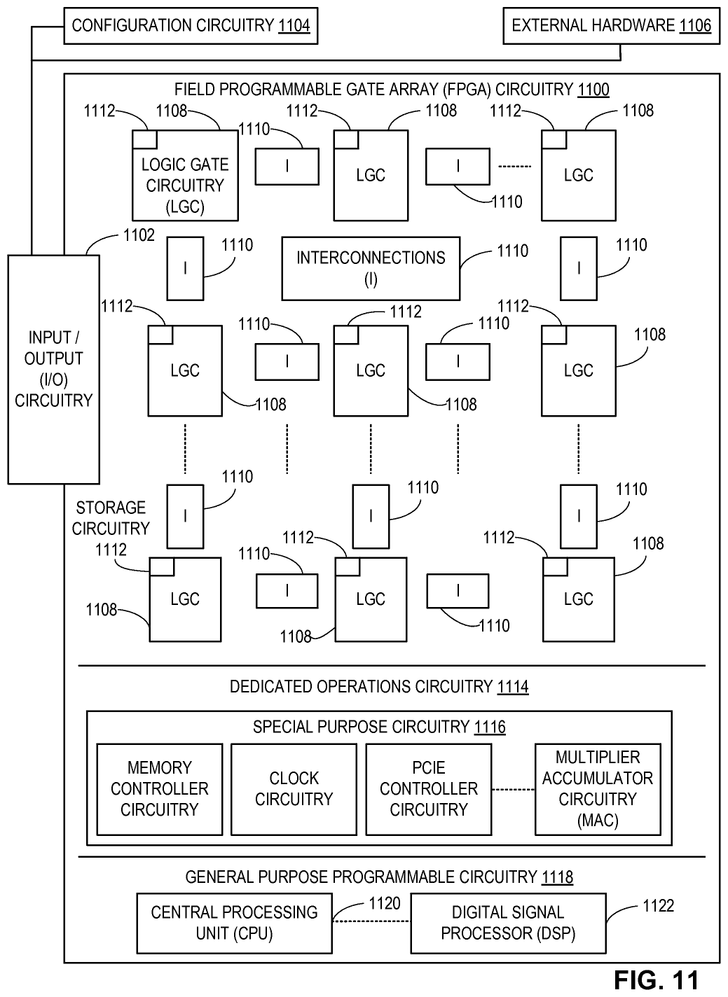

In some examples, the e-mail management circuitry 202 includes means for managing e-mail, the item management circuitry 204 includes means for managing items, the item solicitation circuitry 206 includes means for soliciting items, the purchaser management circuitry 208 includes means for managing purchases, and the transaction circuitry 106 includes means for transaction management. For example, the means for managing e-mail may be implemented by the example e-mail management circuitry 202, the means for managing items may be implemented by the example item management circuitry 204, the means for soliciting items may be implemented by the example item solicitation circuitry 206, the means for managing purchases may be implemented by the example purchaser management circuitry 208, and the means for transaction management may be implemented by the example transaction circuitry 106. In some examples, the aforementioned circuitry may be instantiated by processor circuitry such as the example processor circuitry 912 of FIG. 9. For instance, the aforementioned circuitry may be instantiated by the example microprocessor 1000 of FIG. 10 executing machine executable instructions such as those implemented by one or more blocks of FIGS. 3-8. In some examples, the aforementioned circuitry may be instantiated by hardware logic circuitry, which may be implemented by an ASIC, XPU, or the FPGA circuitry 1100 of FIG. 11 structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the example transaction circuitry 106 of FIGS. 1 and 2A are illustrated in FIG. 2A, one or more of the elements, processes, and/or devices illustrated in FIGS. 1 and 2A may be combined, divided, re-arranged, omitted, eliminated, and/or implemented in any other way. Further, the example e-mail management circuitry 202, the example item management circuitry 204, the example item solicitation circuitry 206, the example purchaser management circuitry 208, and/or, more generally, the example transaction circuitry 106 of FIGS. 1 and 2A, may be implemented by hardware alone or by hardware in combination with software and/or firmware. Thus, for example, any of the example e-mail management circuitry 202, the example item management circuitry 204, the example item solicitation circuitry 206, the example purchaser management circuitry 208, and/or, more generally, the example transaction circuitry 106 of FIGS. 1 and 2A, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example transaction circuitry 106 of FIGS. 1 and 2A may include one or more elements, processes, and/or devices in addition to, or instead of, those illustrated in FIGS. 1 and 2A, and/or may include more than one of any or all of the illustrated elements, processes and devices.

Flowcharts representative of example machine readable instructions, which may be executed to configure processor circuitry to implement the transaction circuitry 106 of FIGS. 1 and 2A, are shown in FIGS. 3-8. The machine readable instructions may be one or more executable programs or portion(s) of an executable program for execution by processor circuitry, such as the processor circuitry 912 shown in the example processor platform 900 discussed below in connection with FIG. 9 and/or the example processor circuitry discussed below in connection with FIGS. 10 and/or 11. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3-8, many other methods of implementing the example transaction circuitry 106 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-8 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to facilitate participant connections when buying and selling goods that have been previously purchased by the seller. The machine readable instructions and/or the operations 300 of FIG. 3 begin at block 301, at which the example transaction circuitry 106 determines whether a selling or a buying operation is to occur. In particular, in the event of a selling operation (e.g., initiated by a selling participant), the example e-mail management circuitry manages e-mail access authentication, category selections and e-mail searching (block 302) as discussed above and in further detail below. The example item management circuitry 204 manages generating lists of candidate products to offer for sale (block 304) as discussed above and in further detail below. The example item solicitation circuitry 206 manages the display and/or otherwise rendering of items to offer for sale and handles offers that may occur (block 306) as discussed above and in further detail below. In the event the example transaction server 106 determines that a buy operation is to occur (block 301), the example purchaser management circuitry 208 handles buyer data retrieval (block 308) and buyer transaction management (block 310), as described above and in further detail below.

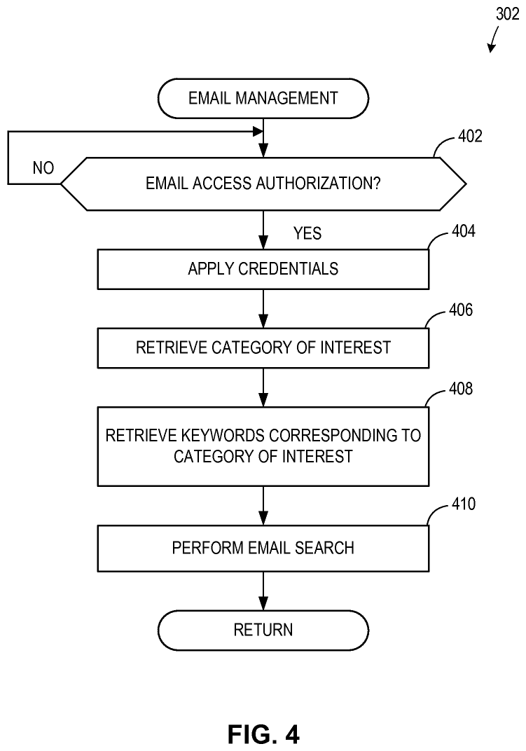

FIG. 4 illustrates additional detail corresponding to e-mail management (block 302) of FIG. 3. In the illustrated example of FIG. 4, the e-mail management circuitry 202 determines whether the transaction circuitry 106 and/or the device participating in sale activity (e.g., one of the computing devices 102) has authorization to access e-mail (block 402). If not, then the example process (block 302) waits for such authorization, otherwise the example e-mail management circuitry 202 applies needed credentials to allow access to e-mail content (block 404). As discussed above, the e-mail management circuitry 202 may alternatively gain access to one or more e-mail apps of the participant computing device for screen access, scraping and/or word search capabilities, thereby avoiding the need to relinquish e-mail credentials. The example e-mail management circuitry 202 retrieves one or more categories of interest that will be used to constrain search results (block 406) and retrieves corresponding keywords to facilitate the search of e-mail messages (block 408). The example e-mail management circuitry 202 then performs a search of the e-mail messages in view of the provided keywords and/or other parameters (e.g., a particular threshold age of an e-mail message).

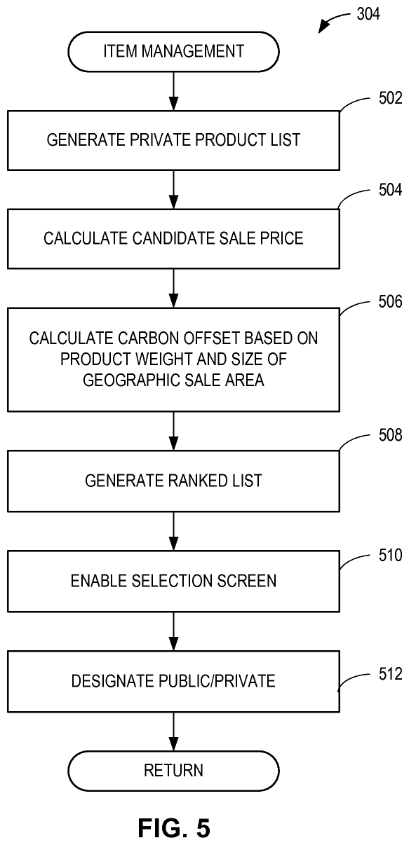

FIG. 5 illustrates additional detail corresponding to item management (block 304) of FIG. 3. In the illustrated example of FIG. 5, the example item management circuitry 204 generates a private product list of detected products found in the e-mail search (block 502). As discussed above, initial lists of products found during the e-mail search are designated and/or otherwise assigned with a private status so that only the selling participant can view candidate products to be sold. The example item management circuitry 204 calculates a candidate sale price (block 504), and calculates a carbon offset value (block 506). In some examples, the carbon offset value is calculated based on a product weight and a maximum size of a geographic sale area. The example item management circuitry 204 generates a ranked product list (block 508), in which ranking criteria may include price (e.g., highest to lowest), carbon offset values (e.g., highest to lowest), and/or any other ranking criteria. The example item management circuitry 204 enables and/or otherwise renders a selection screen for the selling participant (block 510), which shows the ranked list and an opportunity to designate (assign) each one of the items as either public or private (block 512).

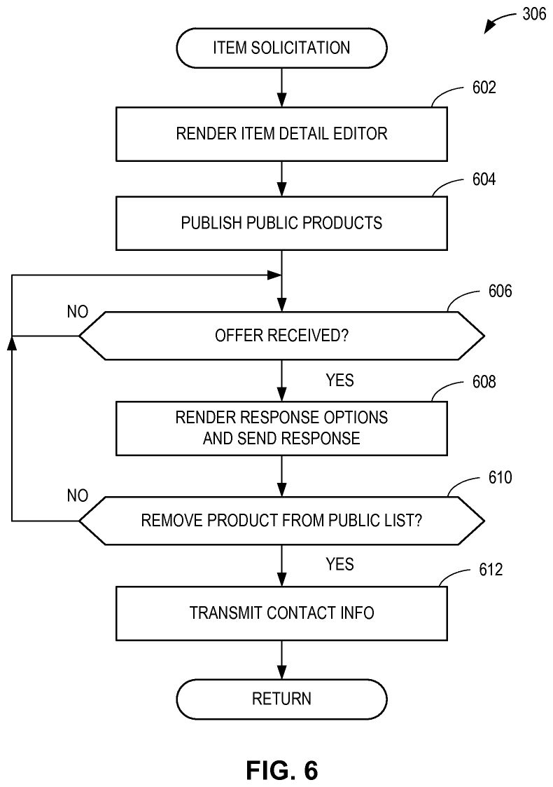

FIG. 6 illustrates additional detail corresponding to item solicitation (block 306) of FIG. 3. In the illustrated example of FIG. 6, the example item solicitation circuitry 206 renders an item detail editor (block 602). In particular, the selling participant may augment details corresponding to a selected product from the ranked list, such as additional details related to the product condition (e.g., no scratches, original wrapping, heavily used, etc.). The example item solicitation circuitry 206 publishes the products assigned and/or otherwise designated as public (block 604) and awaits confirmation that an offer is received (block 606). In response to receiving an offer, the example item solicitation circuitry 206 renders response options from the selling participant (e.g., agree with the offer, produce a counter offer, etc.) and sends the response to the offeror (block 608). Depending on the offeror's input, the example item solicitation circuitry 206 leaves the product on the public list (e.g., because the seller participant did not agree to the sale price) and control returns to block 606 to await a new offer. However, in the event the selling participant agrees to sell the product, the product is removed from the public list (block 610) and transmits a second combination of information corresponding to contact information of the seller participant (block 612).

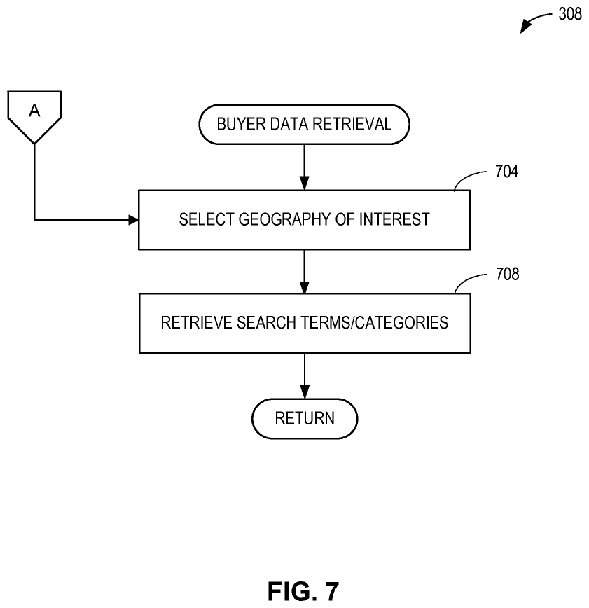

FIG. 7 illustrates additional detail corresponding to buyer data retrieval (block 308) of FIG. 3. In the illustrated example of FIG. 7, the example purchaser management circuitry 208 selects a geography of interest identified by a user (block 704) (e.g., a user of one of the computing devices 102 executing the example transaction circuitry 106). The example purchaser management circuitry 208 then retrieves corresponding search terms and/or category selections that are relevant to the selected geography of interest (block 708).

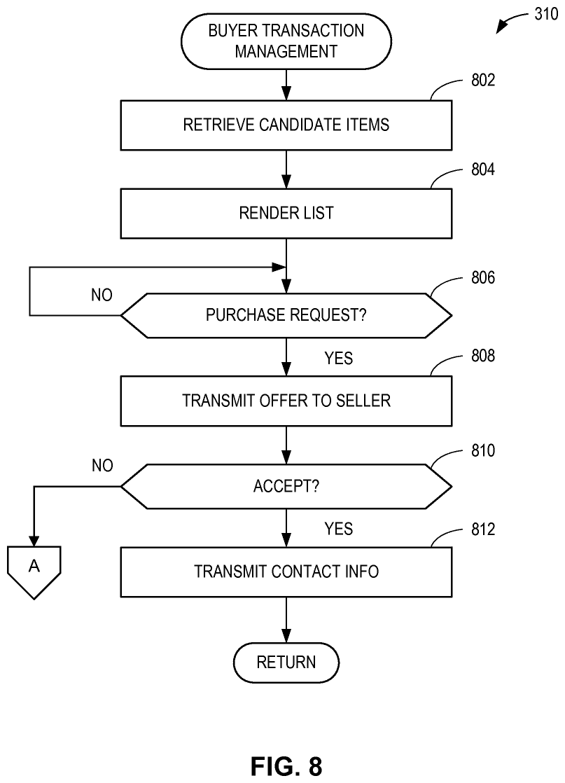

FIG. 8 illustrates additional detail corresponding to buyer transaction management (block 310) of FIG. 3. In the illustrated example of FIG. 8, the purchaser management circuitry 208 retrieves candidate items that satisfy the geographic area of interest, category selections and/or keyword selections from the buyer participant (block 802). The example purchaser management circuitry 208 renders a list of candidate products (block 804) and determines if a purchase request occurs (block 806). If so, the purchaser management circuitry 208 transmits an offer to the seller (block 808) and determines whether the offer is accepted (block 810). If not, control returns to block 704 of FIG. 7, otherwise the example purchaser management circuitry 208 transmits contact information to the selling participant to enable the parties to meet and complete the negotiations/sale (block 812).

FIG. 9 is a block diagram of an example processor platform 900 structured to execute and/or instantiate the machine readable instructions and/or the operations of FIGS. 3-8 to implement the transaction circuitry 106 of FIGS. 1 and 2A. The processor platform 900 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 900 of the illustrated example includes processor circuitry 912. The processor circuitry 912 of the illustrated example is hardware. For example, the processor circuitry 912 can be implemented by one or more integrated circuits, logic circuits, FPGAs, microprocessors, CPUs, GPUs, DSPs, and/or microcontrollers from any desired family or manufacturer. The processor circuitry 912 may be implemented by one or more semiconductor based (e.g., silicon based) devices. In this example, the processor circuitry 412 implements the example e-mail management circuitry 202, the example item management circuitry 204, the example item solicitation circuitry 206, the example purchaser management circuitry 208 and the example transaction circuitry 106.

The processor circuitry 912 of the illustrated example includes a local memory 913 (e.g., a cache, registers, etc.). The processor circuitry 912 of the illustrated example is in communication with a main memory including a volatile memory 914 and a non-volatile memory 916 by a bus 918. The volatile memory 914 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 916 may be implemented by flash memory and/or any other desired type of memory device. Access to the main memory 914, 916 of the illustrated example is controlled by a memory controller 917.

The processor platform 900 of the illustrated example also includes interface circuitry 920. The interface circuitry 920 may be implemented by hardware in accordance with any type of interface standard, such as an Ethernet interface, a universal serial bus (USB) interface, a Bluetooth®) interface, a near field communication (NFC) interface, a Peripheral Component Interconnect (PCI) interface, and/or a Peripheral Component Interconnect Express (PCIe) interface.

In the illustrated example, one or more input devices 922 are connected to the interface circuitry 920. The input device(s) 922 permit(s) a user to enter data and/or commands into the processor circuitry 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuitry 920 of the illustrated example. The output device(s) 924 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 920 of the illustrated example, thus, typically includes a graphics driver card, a graphics driver chip, and/or graphics processor circuitry such as a GPU.

The interface circuitry 920 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 926. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 900 of the illustrated example also includes one or more mass storage devices 928 to store software and/or data. Examples of such mass storage devices 928 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 932, which may be implemented by the machine readable instructions of FIGS. 3-8, may be stored in the mass storage device 928, in the volatile memory 914, in the non-volatile memory 916, and/or on a removable non-transitory computer readable storage medium such as a CD or DVD.

FIG. 10 is a block diagram of an example implementation of the processor circuitry 912 of FIG. 9. In this example, the processor circuitry 912 of FIG. 9 is implemented by a microprocessor 1000. For example, the microprocessor 1000 may be a general purpose microprocessor (e.g., general purpose microprocessor circuitry). The microprocessor 1000 executes some or all of the machine readable instructions of the flowcharts of FIGS. 3-8 to effectively instantiate the circuitry of FIGS. 1 and 2A as logic circuits to perform the operations corresponding to those machine readable instructions. In some such examples, the circuitry of FIGS. 1 and 2A is instantiated by the hardware circuits of the microprocessor 1000 in combination with the instructions. For example, the microprocessor 1000 may be implemented by multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowcharts of FIGS. 1 and 2A.

The cores 1002 may communicate by a first example bus 1004. In some examples, the first bus 1004 may be implemented by a communication bus to effectuate communication associated with one(s) of the cores 1002. For example, the first bus 1004 may be implemented by at least one of an Inter-Integrated Circuit (I2C) bus, a Serial Peripheral Interface (SPI) bus, a PCI bus, or a PCIe bus. Additionally or alternatively, the first bus 1004 may be implemented by any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2 cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 914, 916 of FIG. 9). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the local memory 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may be implemented by at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 912 of FIG. 9. In this example, the processor circuitry 912 is implemented by FPGA circuitry 1100. For example, the FPGA circuitry 1100 may be implemented by an FPGA. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 3-8 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowcharts of FIGS. 3-8. In particular, the FPGA circuitry 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 3-8. As such, the FPGA circuitry 1100 may be structured to effectively instantiate some or all of the machine readable instructions of the flowcharts of FIGS. 3-8 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 3-8 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware 1106. For example, the configuration circuitry 1104 may be implemented by interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may be implemented by external hardware circuitry. For example, the external hardware 1106 may be implemented by the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and the configurable interconnections 1110 are configurable to instantiate one or more operations that may correspond to at least some of the machine readable instructions of FIGS. 3-8 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The configurable interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 912 of FIG. 9, many other approaches are contemplated. For example, as mentioned above, modern FPGA circuitry may include an on-board CPU, such as one or more of the example CPU 1120 of FIG. 11. Therefore, the processor circuitry 912 of FIG. 9 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 3-8 may be executed by one or more of the cores 1002 of FIG. 10, a second portion of the machine readable instructions represented by the flowcharts of FIGS. 3-8 may be executed by the FPGA circuitry 1100 of FIG. 11, and/or a third portion of the machine readable instructions represented by the flowcharts of FIGS. 3-8 may be executed by an ASIC. It should be understood that some or all of the circuitry of FIGS. 1 and 2A may, thus, be instantiated at the same or different times. Some or all of the circuitry may be instantiated, for example, in one or more threads executing concurrently and/or in series. Moreover, in some examples, some or all of the circuitry of FIGS. 1 and 2A may be implemented within one or more virtual machines and/or containers executing on the microprocessor.

In some examples, the processor circuitry 912 of FIG. 9 may be in one or more packages. For example, the microprocessor 1000 of FIG. 10 and/or the FPGA circuitry 1100 of FIG. 11 may be in one or more packages. In some examples, an XPU may be implemented by the processor circuitry 912 of FIG. 9, which may be in one or more packages. For example, the XPU may include a CPU in one package, a DSP in another package, a GPU in yet another package, and an FPGA in still yet another package.

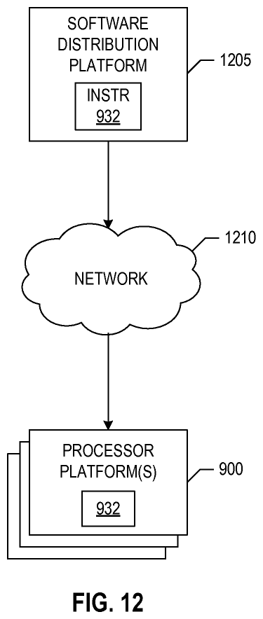

A block diagram illustrating an example software distribution platform 1205 to distribute software such as the example machine readable instructions 932 of FIG. 9 to hardware devices owned and/or operated by third parties is illustrated in FIG. 12. The example software distribution platform 1205 may be implemented by any computer server, data facility, cloud service, etc., capable of storing and transmitting software to other computing devices. The third parties may be customers of the entity owning and/or operating the software distribution platform 1205. For example, the entity that owns and/or operates the software distribution platform 1205 may be a developer, a seller, and/or a licensor of software such as the example machine readable instructions 932 of FIG. 9. The third parties may be consumers, users, retailers, OEMs, etc., who purchase and/or license the software for use and/or re-sale and/or sub-licensing. In the illustrated example, the software distribution platform 1205 includes one or more servers and one or more storage devices. The storage devices store the machine readable instructions 932, which may correspond to the example machine readable instructions of FIGS. 3-8, as described above. The one or more servers of the example software distribution platform 1205 are in communication with an example network 1210, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 932 from the software distribution platform 1205. For example, the software, which may correspond to the example machine readable instructions of FIGS. 3-8, may be downloaded to the example processor platform 900, which is to execute the machine readable instructions 932 to implement the transaction circuitry 106. In some examples, one or more servers of the software distribution platform 1205 periodically offer, transmit, and/or force updates to the software (e.g., the example machine readable instructions 932 of FIG. 9) to ensure improvements, patches, updates, etc., are distributed and applied to the software at the end user devices.

Example methods, apparatus, systems, and articles of manufacture to facilitate participant connection. Further examples and combinations thereof include the following:
Example 1 includes an apparatus to facilitate participant connection comprising interface circuitry to retrieve participant information, and processor circuitry including one or more of at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations, the processor circuitry to perform at least one of the first operations, the second operations, or the third operations to instantiate electronic mail (e-mail) management circuitry to authorize access to an e-mail account, parse messages corresponding to the e-mail account to identify parameters, generate a list of candidate products associated with the parameters, and publish the list with a first combination of information, item solicitation circuitry to, in response to a first trigger, publish a second combination of information, and transaction circuitry to cause one of the candidate products from the list of candidate products to be at least one of removed or maintained based on a second trigger.
Example 2 includes the apparatus as defined in example 1, wherein the e-mail management circuitry is to provide account credentials to an e-mail server.
Example 3 includes the apparatus as defined in example 1, wherein the authorization includes permitting access to an e-mail application of a wireless telephone.
Example 4 includes the apparatus as defined in example 1, wherein the parameters include at least one of keywords or threshold age values corresponding to e-mail messages.
Example 5 includes the apparatus as defined in example 1, wherein the list is ranked based on a carbon footprint value.
Example 6 includes the apparatus as defined in example 1, wherein the first combination of information includes at least one of a product name, a product description, a sale price, an original purchase price, or a product age.
Example 7 includes the apparatus as defined in example 6, wherein the first combination of information is published to a public audience.
Example 8 includes the apparatus as defined in example 1, wherein the second combination of information includes at least one of an offer price, a counteroffer price, or address information.
Example 9 includes the apparatus as defined in example 8, wherein the second combination of information is published to a private audience.
Example 10 includes the apparatus as defined in example 1, wherein the first trigger includes an offer from a candidate buyer to purchase one of the candidate products from the list.
Example 11 includes the apparatus as defined in example 10, wherein the second trigger includes an acceptance to the offer.
Example 12 includes an apparatus comprising at least one memory, machine readable instructions, and processor circuitry to at least one of instantiate or execute the machine readable instructions to authorize access to an e-mail account, parse messages corresponding to the e-mail account to identify parameters, generate a list of candidate products associated with the parameters, publish the list with a first combination of information, in response to a first trigger, publish a second combination of information, and cause one of the candidate products from the list of candidate products to be at least one of removed or maintained based on a second trigger.
Example 13 includes the apparatus as defined in example 12, wherein the processor circuitry is to cause account credentials to be provided to an e-mail server.
Example 14 includes the apparatus as defined in example 12, wherein the processor circuitry is to cause authorization of e-mail application access.
Example 15 includes the apparatus as defined in example 12, wherein the processor circuitry is to identify the parameters as at least one of keywords or threshold age values corresponding to e-mail messages.
Example 16 includes the apparatus as defined in example 12, wherein the processor circuitry is to rank the list based on a carbon footprint value.
Example 17 includes the apparatus as defined in example 12, wherein the processor circuitry is to identify the first combination of information as at least one of a product name, a product description, a sale price, an original purchase price, or a product age.
Example 18 includes the apparatus as defined in example 17, wherein the processor circuitry is to cause the first combination of information to be published to a public audience.
Example 19 includes the apparatus as defined in example 12, wherein the processor circuitry is to identify the second combination of information as at least one of an offer price, a counteroffer price, or address information.
Example 20 includes the apparatus as defined in example 19, wherein the processor circuitry is to cause the second combination of information to be published to a private audience.
Example 21 includes a non-transitory machine readable storage medium comprising instructions that, when executed, cause processor circuitry to at least authorize access to an e-mail account, parse messages corresponding to the e-mail account to identify parameters, generate a list of candidate products associated with the parameters, publish the list with a first combination of information, in response to a first trigger, publish a second combination of information, and cause one of the candidate products from the list of candidate products to be at least one of removed or maintained based on a second trigger.
Example 22 includes the non-transitory machine readable storage medium as defined in example 21, wherein the instructions, when executed, cause the processor circuitry to cause account credentials to be provided to an e-mail server.
Example 23 includes the non-transitory machine readable storage medium as defined in example 21, wherein the instructions, when executed, cause the processor circuitry to cause authorization of e-mail application access.
Example 24 includes the non-transitory machine readable storage medium as defined in example 21, wherein the instructions, when executed, cause the processor circuitry to cause identification of the parameters as at least one of keywords or threshold age values corresponding to e-mail messages.
Example 25 includes the non-transitory machine readable storage medium as defined in example 21, wherein the instructions, when executed, cause the processor circuitry to cause the list to be ranked based on a carbon footprint value.

From the foregoing, it will be appreciated that example systems, methods, apparatus, and articles of manufacture have been disclosed that improve the technical field of electronic transactions and enable improved fiscal efficiency and improved carbon footprint savings for electronic transactions.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1-25. (canceled)

26. An apparatus comprising:
interface circuitry;
machine-readable instructions; and
at least one processor circuit to be programmed by the machine-readable instructions to:
scan a memory to identify objects associated with target parameters;
cause display of a first user interface (UI) containing a list of the identified objects and selectable icons on the first UI next to the identified objects;
detect selection of one or more of the selectable icons;
re-assign ones of the identified objects with a public status based on selected ones of the selectable icons;
transmit the ones of the identified objects having the public status to a network for display on a second UI;
rank the identified objects having the public status based on an associated carbon offset value; and
cause display of a ranked list of the one or more of the identified objects having the public status on the second UI.

27. The apparatus as defined in claim 26, wherein the memory is in a wireless telephone, one or more of the at least one processor circuit is to parse messages of the wireless telephone to identify the target parameters.

28. The apparatus as defined in claim 27, wherein one or more of the at least one processor circuit is to identify the objects having target parameters corresponding to a geographical location.

29. The apparatus as defined in claim 26, wherein one or more of the at least one processor circuit is to cause display of a first data structure on the second UI at a first time, the first data structure based on a first status of the ranked list of the ones of the identified objects.

30. The apparatus as defined in claim 29, wherein one or more of the at least one processor circuit is to enable access of the first data structure to users of the network.

31. The apparatus as defined in claim 30, wherein one or more of the at least one processor circuit is to:
identify ones of the identified objects associated with a second status; and
cause display of a second data structure on the second UI at a second time, the second data structure displayed to ones of the users of the network.

32. The apparatus as defined in claim 31, wherein the first data structure includes information corresponding to at least one of a product name, a product description, a sale price, an original purchase price, or a product age.

33. The apparatus as defined in claim 31, wherein the second data structure includes information corresponding to at least one of an offer price, a counteroffer price, or address information.

34. The apparatus as defined in claim 26, wherein one or more of the at least one processor circuit is to prevent transmission of the identified objects to a network by assigning the identified objects with a private status.

35. At least one non-transitory machine-readable medium comprising machine-readable instructions to cause at least one processor circuit to at least:
scan a memory to identify objects associated with target parameters;
cause display of a first user interface (UI) containing a list of the identified objects and selectable icons on the first UI next to the identified objects;
detect selection of one or more of the selectable icons;
re-assign ones of the identified objects with a public status based on selected ones of the selectable icons;
transmit the ones of the identified objects having the public status to a network for display on a second UI;
rank the identified objects having the public status based on an associated carbon offset value; and
cause display of a ranked list of the one or more of the identified objects having the public status on the second UI.

36. The at least one non-transitory machine-readable medium as defined in claim 35, wherein the machine-readable instructions are to cause one or more of the at least one processor circuit to parse messages of a wireless telephone to identify the target parameters.

37. The at least one non-transitory machine-readable medium as defined in claim 36, wherein the machine-readable instructions are to cause one or more of the at least one processor circuit to identify the objects having target parameters corresponding to a geographical location.

38. The at least one non-transitory machine-readable medium as defined in claim 35, wherein the machine-readable instructions are to cause one or more of the at least one processor circuit to cause display of a first data structure on the second UI at a first time, the first data structure based on a first status of the ranked list of the ones of the identified objects.

39. The at least one non-transitory machine-readable medium as defined in claim 38, wherein the machine-readable instructions are to cause one or more of the at least one processor circuit to enable access of the first data structure to users of the network.

40. The at least one non-transitory machine-readable medium as defined in claim 39, wherein the machine-readable instructions are to cause one or more of the at least one processor circuit to:
identify ones of the identified objects associated with a second status; and
cause display of a second data structure on the second UI at a second time, the second data structure displayed to ones of the users of the network.

41. The at least one non-transitory machine-readable medium as defined in claim 40, wherein the machine-readable instructions are to cause one or more of the at least one processor circuit to identify the first data structure having at least one of a product name, a product description, a sale price, an original purchase price, or a product age.

42. The at least one non-transitory machine-readable medium as defined in claim 40, wherein the machine-readable instructions are to cause one or more of the at least one processor circuit to identify the second data structure having at least one of an offer price, a counteroffer price, or address information.

43. The at least one non-transitory machine-readable medium as defined in claim 35, wherein the machine-readable instructions are to cause one or more of the at least one processor circuit to prevent transmission of the identified objects to a network by assigning the identified objects with a private status.

44. An apparatus comprising:
means for e-mail management to scan a memory to identify objects associated with target parameters;
means for item management to:
display a first user interface (UI) containing a list of the identified objects and selectable icons on the first UI next to the identified objects;
detect selection of one or more of the selectable icons;
assign ones of the identified objects with a public status based on selected ones of the selectable icons; and
means for item solicitation to transmit ones of the identified objects having the public status to a network for display on a second UI, the means for item management to rank the identified objects having the public status based on an associated carbon offset value, and the means for item management to display a ranked list of the one or more of the identified objects having the public status on the second UI.

45. The apparatus as defined in claim 44, wherein the means for e-mail management is to parse messages of a wireless telephone to identify the target parameters.
